(19) United States
(12) Patent Application Publication
(10) Pub. No.: US 2015/0028758 A1
(43) Pub. Date: Jan. 29, 2015

(54) ISOLATING MINIMAL SWITCHED POWER SUPPLY

(71) Applicant: Hans-Wolfgang Diesing, Schoengeising (DE)

(72) Inventor: Hans-Wolfgang Diesing, Schoengeising (DE)

(21) Appl. No.: 14/349,643

(22) PCT Filed: Oct. 3, 2012
(86) PCT No.: PCT/DE2012/000968

§ 371 Date: Jun. 6, 2014

(30) Foreign Application Priority Data
Oct. 4, 2011 (DE) 20 2011 106 228.0

(51) Int. Cl. H02M 7/12; H02M 1/14; H01J 61/02

(52) U.S. Cl. CPC H02M 7/12; H01J 61/02; H02M 1/14
USPC 315/200 R; 363/126

(57) ABSTRACT

Conventional linear or switched power supplies do not sufficiently meet increased requirements for the lowest possible standby losses in idle current mode or ready mode, or for maintaining the charge in storage capacitors or rechargeable batteries even when said supplies have significantly increased circuit complexity. The proposed schematic diagram provides a solution which, in comparison to prior art, can produce a large-scale reduction in said standby losses using a breakover voltage diode, such as e.g. DIAC, SIDAC, TRISIL, or a glow lamp, which, once the respective breakover voltage or triggering voltage has been reached, repeatedly discharges a high-voltage charging capacitor via the primary winding of a pulse transformer, said capacitor in limiting the alternating current with zero-loss and being continuously re-charged by means of a high-voltage input charging capacitor in the surge and ebb supply voltage phases. The pulse bursts of the pulse transformer are rectified on the secondary side and smoothed by means of a buffer capacitor. As the output voltage is clearly dependent on a variable load impedance, a linear fixed voltage regulator with minimal power losses can be connected downstream to stabilise the voltage, without appreciably affecting the energy balance. Sensors that have been decentrally installed can thus be supplied, or a minimal voltage supply for load monitoring and prompt readiness can thus be provided, even for larger switched power supplies and load parts.

### PRIOR ART

There currently exist switched-mode power supplies that offer over 50% efficiency in the 100 mW range, distinct from linear power supplies that already have transformer losses of more than 400 mW. Below this load, however, even in the best switched-mode power supplies, the efficiency decreases rapidly and in idle current mode, a power consumption of 30 mW can hardly be reduced. Capacitor-based and non-isolating switched power supplies in the best case achieve 20 mW idle-mode power consumption. International energy efficiency standards strive for an idle-mode consumption of less than 10 mW, which cannot be provided with conventional circuit designs or can only be provided by a sleep mode, which it is possible to change, however, only by an external wake-up signal that in turn requires a separate power supply.

There is, of course, quite a gap relative to the demand for power supplies or even AC-supplied auxiliary power sources in the range below 10 mW, e.g., for standby modes of switched power supplies and load parts, for supplying decentrally distributed stationary sensor networks in alarm systems, in building automation, in medical and industrial electronics, as well as for standby of devices for entertainment and communications electronics or intelligent household appliances, etc. The invention in this application meets this requirement for network-isolated, efficiency-optimized, minimal-current power supplies. Based on highly isolating pulse transformers, as are offered for the isolation of communications networks and of DIAC four-layer diode, as are common in TRIAC-based forward-phase dimmers, pulse bursts of the alternating current supply voltage, which are limited by high-voltage capacitors, interacting with the inductance of the pulse transformer and a high-voltage storage capacitor can be generated practically with zero loss; these pulse bursts are rectified in the secondary circuit of the pulse transformer via a diode bridge and are smoothed by a buffer capacitor. Since the output voltage changes with variable load impedance, a linear voltage regulator with minimal power loss can be connected downstream for voltage stabilization without notably adversely affecting the energy balance. In this way, e.g., decentrally installed sensors can be supplied or a minimal voltage supply can be offered for load monitoring and prompt readiness, even for larger switched-mode power supplies and load parts.

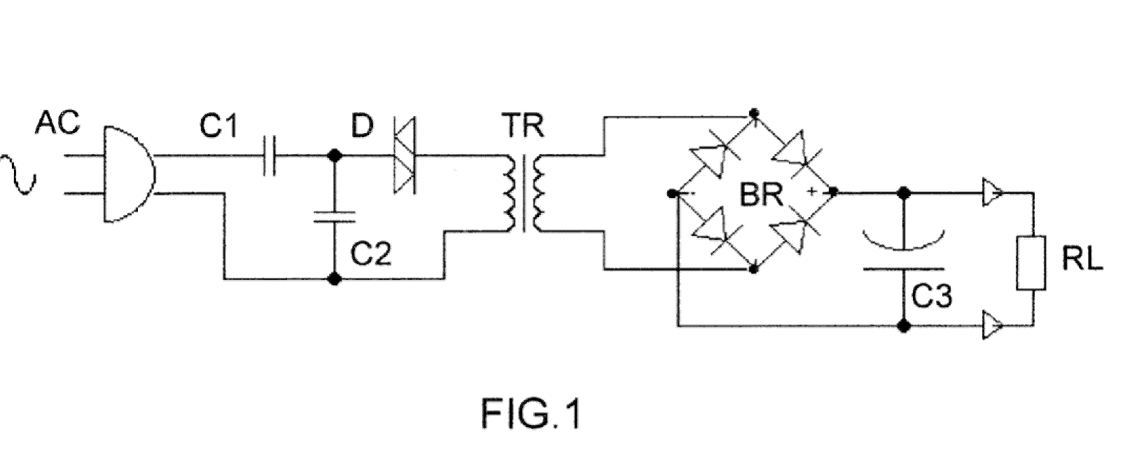

FIG. 1 shows the diagram of such a circuit:

Therein, AC is the supply voltage source, C1 is a limiting high-voltage input capacitor, C2 is a high-voltage storage capacitor, and D is a DIAC or a multi-layer breakover voltage diode, gas discharge tube or glow lamp, TR is an isolating pulse transformer, BR is a rectifier bridge, and C3 is a buffer capacitor.

Function: While the voltage increases at C2, at approximately 32 volts the breakthrough of the DIAC D occurs, which leads to a discharge pulse via the primary winding of the pulse transformer TR. A repeated increase in the capacitor voltage via the continued surging power supply half-phase leads to further discharge pulses until the peak voltage of the power supply half-phase (or its first derivative) is reached and the pulse salvo dies out. The diode bridge BR introduces the rectified pulses from the secondary winding of the pulse transformer TR to a buffer capacitor C3, which smoothes the output voltage via the load resistor RL. With variable output load, a linear voltage regulator can be connected downstream to the buffer capacitor C3 as needed in a well-known way. Such regulators with minimal regulating losses are available as integrated circuits (e.g. MCP1702) for different fixed output voltages with a regulating loss of 0.4 μW.

An output voltage between 2 V and 4 V with a maximum output power of almost 0.8 mW was produced experimentally in a circuit structure with load resistors between 4.7 kOhm and 47 kOhm. A power consumption from the supply voltage could not be measured since it was less than the measurement resolution of 1 mW.

1. An isolating minimal switched power supply according to appended circuit diagram, is hereby characterized
in that a pulse transformer inductively transforms the nearly loss-free discharge pulses of a high-voltage storage capacitor that are limited by a high-voltage input capacitor at the AC power supply during startup (power on) of the supply half-phase via a DIAC four-layer diode onto the secondary circuit with rectifier and buffer capacitor for smoothing the output voltage.

2. An isolating minimal switched power supply according to appended circuit diagram, is hereby characterized
in that a pulse transformer inductively transforms the nearly loss-free discharge pulses of a high-voltage storage capacitor that are limited by a high-voltage input capacitor at the AC power supply during startup (power on) of the supply half-phase via a multilayer semiconductor breakover voltage diode onto the secondary circuit with rectifier and buffer capacitor for smoothing the output voltage,
the breakover voltage diode being embodied as a SIDAC, TRISIL or Shockley diode with breakover voltages typical of the technology or with breakover voltages adjustable by process technology.

3. An isolating minimal switched power supply according to appended circuit diagram, is hereby characterized
in that a pulse transformer inductively transforms the nearly loss-free discharge pulses of a high-voltage storage capacitor that are limited by a high-voltage input capacitor at the AC power supply during startup (power on) of the supply half-phase via a gas-discharge tube or glow lamp onto the secondary circuit with rectifier and buffer capacitor for smoothing the output voltage, the gas-discharge tube or glow lamp having a suitable triggering voltage below the supply phase peak voltage.

4. The isolating minimal switched power supply according to claim 3, further characterized in that when a gas-discharge tube or a glow lamp or a fluorescent gas-discharge tube or a fluorescent glow lamp is used, an optical operating display can be provided as an optional additional benefit.

5. The isolating minimal switched power supply according to claim 1, further characterized in that a linear voltage regulator is connected downstream for voltage stabilization with variable output load as well as for the active additional smoothing of the output ripple.
